(19) United States
(12) Patent Application Publication
(10) Pub. No.: US 2015/0050119 A1
(43) Pub. Date: Feb. 19, 2015

(54) Railcar Cover Opening Method for a Rotary Dumper

(71) Applicant: Ecofab Covers International Inc., Bridgetown, OT (BB)

(72) Inventors: Trevor Low, North Vancouver (CA); Mark Doldon, North Vancouver (CA); John Cruikshank, Grange (AU)

(21) Appl. No.: 14/388,231

(22) PCT Filed: Mar. 27, 2013
(86) PCT No.: PCT/IB2013/001231

§ 371 Date: Sep. 25, 2014

Related U.S. Application Data
(60) Provisional application No. 61/616,238, filed on Mar. 27, 2012.

(51) Int. Cl. B65G 67/50; B61D 39/00

(52) U.S. Cl. CPC B65G 67/50; B61D 39/001
USPC 414/809

(57) ABSTRACT

A method for unloading a loaded railcar in a rotary dumper, comprising moving a railcar having a railcar cover into an unloading position within a dumper and bracing the railcar for inversion; rotating the railcar approximately 180 degrees in a forward direction while simultaneously rotating the cover about one longitudinal side sill of the railcar in a reverse direction into an open position; maintaining the railcar in an approximately inverted position until the load has been unloaded; rotating the inverted railcar in a reverse direction back into an upright position, while simultaneously rotating the railcar cover in a forward direction into a closed position atop the railcar; unbracing the railcar and moving it out of the rotary dumper. The method may include locking and unlocking the cover, and engaging and disengaging cover lifting components within the dumper.

### FIELD OF THE INVENTION

The present invention relates to railcar cover systems. In particular, the present invention relates to a method for opening a railcar cover in a rotary dumper.

### BACKGROUND OF THE INVENTION

It is known to provide open top railway cars, whether bottom dump hoppers or top unloading gondolas, which may be fitted with removable covers to enclose the top openings. These covers typically may be lifted free of the top of the cars for loading, or, in the case of gondolas, for unloading. Once a load has been loaded or unloaded, the cover may be replaced.

Such covers provide a number of benefits, including product containment, for example, prevention of dust or product losses, which represents an environmental hazard. Other benefits include product protection, for example, protection from rain or snow and protection from debris. Many different granular or powder products may be shipped in this way, including minerals, grains, hazardous waste, coal, and other products. Typically, such covers are fastened onto railcars with various types of clamps or brackets which fix the cover to the car and prevent it from coming loose in transit, but which allow manual or automatic opening in order to handle the cover.

For unloading gondola type railcars, prior art solutions for high volume operations such as coal have included use of a railcar dumper, a large device which rotates about the axis of the railcar couplers or about the axis of centre of gravity of the loaded railcar, completely inverting one or more railcars at a time, while the one or more railcars being dumped may remain coupled to the cars ahead and behind. For such dumpers, railcar covers must be displaced from the top of the railcar to permit unloading operations.

Prior art solutions for cover opening of railcars in rotary dumpers have included lifting of covers within the dumper building over the dumper itself. This method adds time to the dump cycle, and is not suitable for retrofit situations, as dumper buildings typically do not have the space capacity necessary for such a cover lifting mechanism, and many dumpers are constructed with part of their mechanism over top of the car, which would prevent removal of the rail car cover. Such a solution also would not work at the loading end. Accordingly, a new cover opening system for rotary dumping of railcars is needed.

### SUMMARY OF THE INVENTION

In one of its aspects, the invention provides a method for opening a railcar cover within a rotary dumper, comprising the steps of moving a railcar having a railcar cover thereon into an unloading position within a rotary dumper; and rotating the railcar approximately 180 degrees in a forward direction while simultaneously rotating the railcar cover about one longitudinal side in a reverse direction into an open position. Where the railcar cover is locked to the railcar, an intermediate step would be unlocking one side of the railcar cover from the corresponding railcar sill. Where the rotary dumper comprises a plurality of lifting components, a further step in the method of the invention may be the intermediate step of engaging the railcar cover with the plurality of lifting components.

In another of its aspects, the invention provides a method for unloading a loaded railcar in a rotary dumper, comprising the steps of moving a railcar having a railcar cover thereon into an unloading position within a rotary dumper and bracing the railcar for inversion; rotating the railcar approximately 180 degrees in a forward direction while simultaneously rotating the railcar cover about one longitudinal side in a reverse direction into an open position; maintaining the railcar in an approximately inverted position until the load has been unloaded; rotating the inverted railcar in a reverse direction back into an upright position, while simultaneously rotating the railcar cover in a forward direction about one longitudinal side into a closed position atop the railcar; unbracing the railcar and moving it out of the rotary dumper.

### BRIEF DESCRIPTION OF THE DRAWINGS

It is to be expressly understood that the description and drawings are only for the purpose of illustration and as an aid to understanding, which are not intended as a definition of the limits of the invention. In the accompanying drawings, one embodiment of the invention is shown by way of example only, in which:

FIGS. 1, 2, 3, and 4 depict a sequence of perspective views of a covered railcar being dumped in a rotary dumper, according to the method of the present invention; and

FIGS. 5, 6, 7, and 8 depict a sequence of lateral cross-sectional views of a covered railcar being dumped in a rotary dumper, according to the method of the present invention.

### DETAILED DESCRIPTION OF THE INVENTION

The present invention comprises a system for cover opening of railcars in a rotary dumper system. According to one embodiment of a method of the present invention, a loaded railcar is moved into an unloading position within a rotary dumper and braced for inversion. A cover unlocking mechanism unlocks one longitudinal side of the railcar cover from the railcar sill. A cover lift component of the rotary dumper engages with the cover as the rotary dumper rotates to dump the loaded railcar. As the railcar rotates from an upright position into an inverted position, the lift component gradually rotates the cover into an open position to permit the railcar cargo to exit the inverted railcar without obstruction from the railcar cover.

Once the railcar is emptied, the rotary dumper reverses its rotation to move the railcar into an upright position. As the railcar rotates, the lift component reverses the rotation of the cover from a fully open position into a closed position atop the railcar. Finally, the cover is locked and the railcar exits the dumper. The system of the present invention may be employed for dumping separate railcars, or railcars forming part of a continuous train of railcars.

The lift component of the present invention may be any of several devices for engaging with the cover to effect rotation of the cover within a dumper. The lift component may be attached to the end rings of the dumper, or attached to the surrounding fixed structure of the dumper. In a preferred embodiment, the cover opening mechanism is a component of the dumper, but in an alternate embodiment may be attached to one or both railcar ends.

The system of the present invention will function within existing rotary dumpers, provided the end rings of the dumper do not restrict the opening of the cover. For use in an existing dumper in which the end rings would not permit opening of the cover along the entire length of the railcar, an alternate embodiment of the present invention for use with a railcar having a shorter cover fitting between the end rings of such a dumper is also within the scope of the invention.

The method of the present invention is carried out within a rotary dumper apparatus which provides an elongated framework with a first rotation wheel at a first end of the framework, and a second rotation wheel at an opposite second end of the framework. The distance between the first and second rotation wheels may be selected to permit one or more railcars to fit between the opposing wheels, and to permit full sized railcar covers to be opened without obstruction from the wheels. The rotary dumper also provides a plurality of railcar bracing arms, and means for rotation of the rotary dumper.

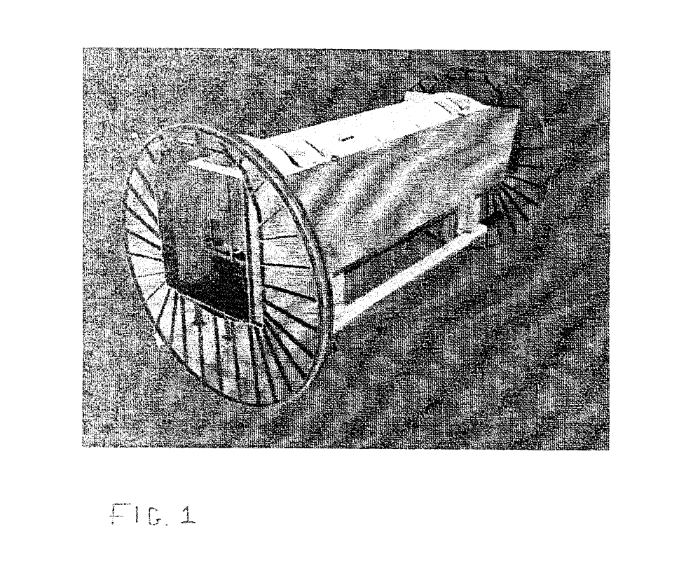

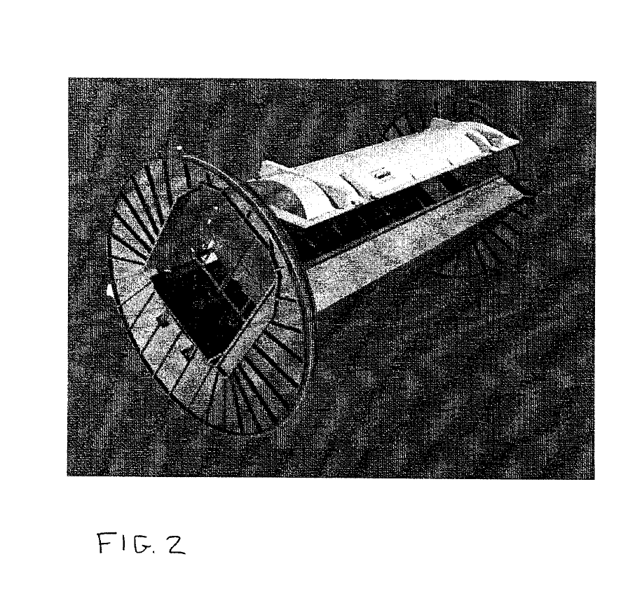

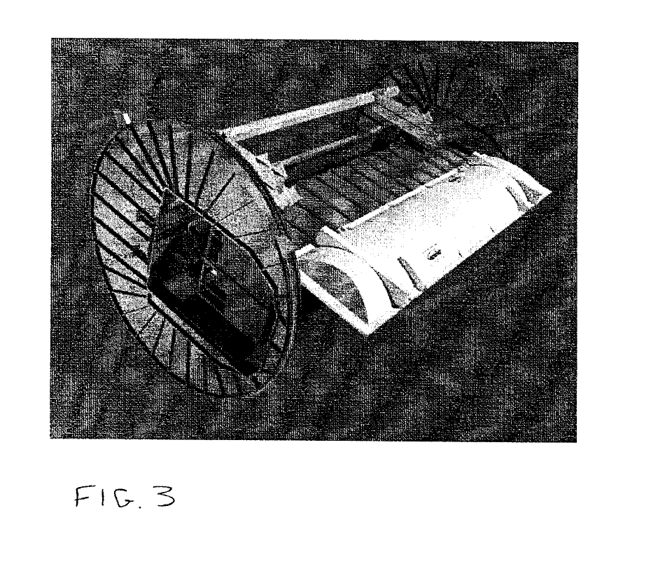

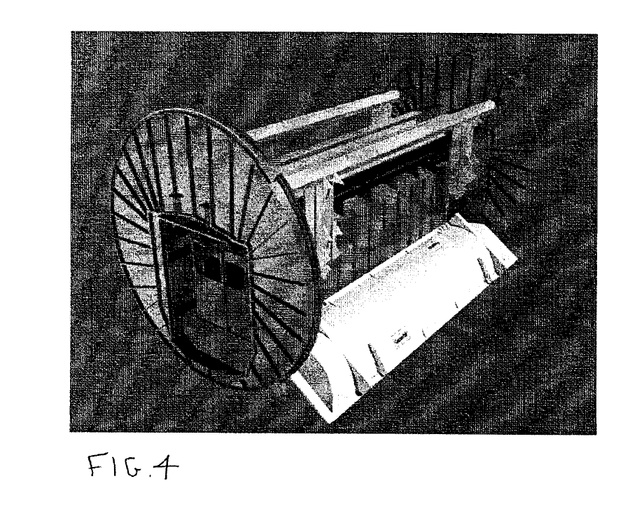

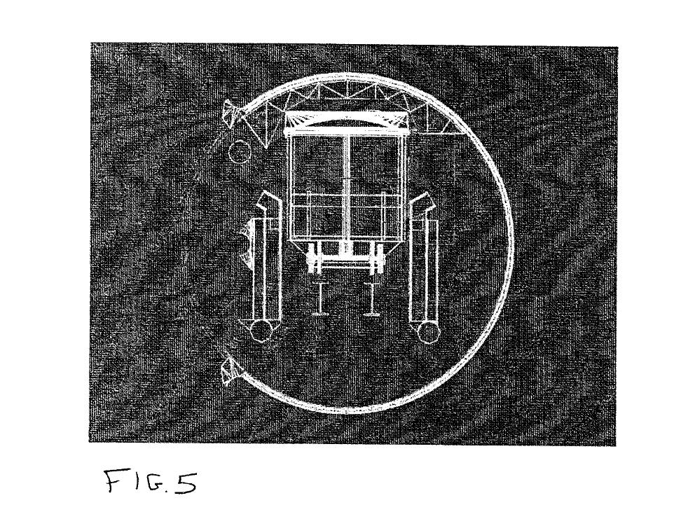

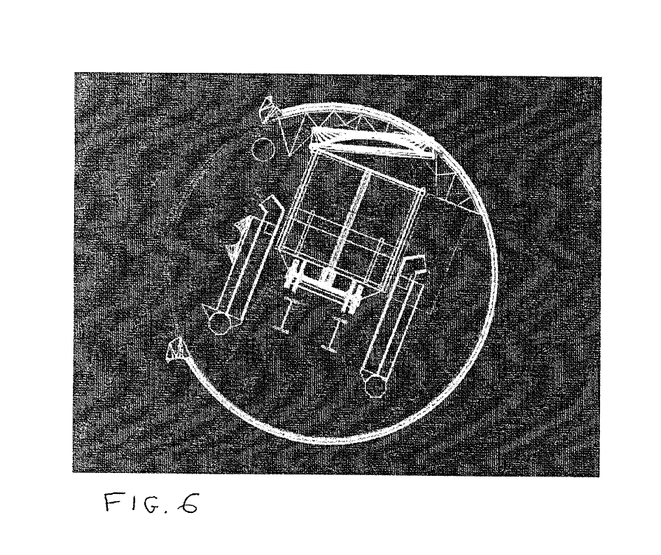

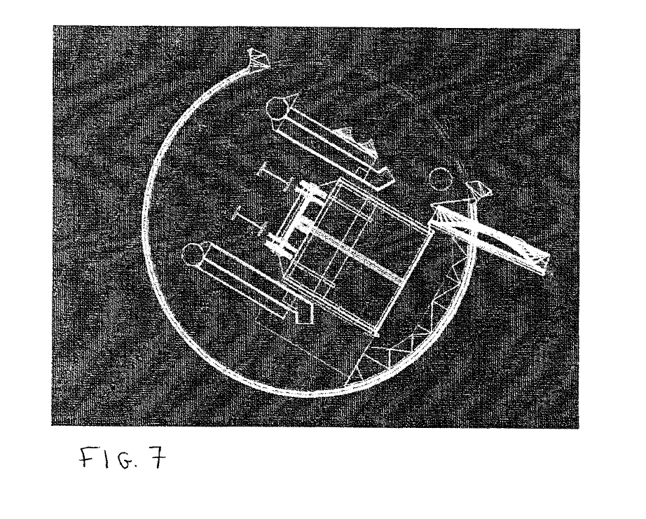

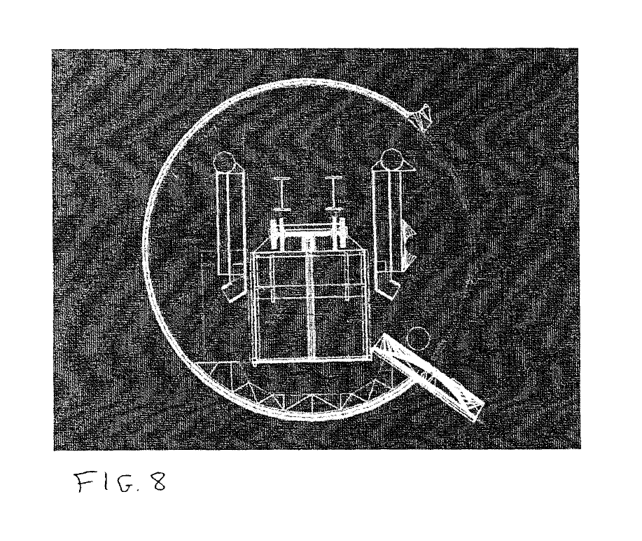

As depicted in FIGS. 1 to 8, in operation a loaded covered railcar is rolled into the framework of the dumper until the railcar is positioned fully between the first and second rotation wheels. The plurality of bracing arms is extended to hold the railcar firmly within the framework. Once braced, the rotation wheels are rotated approximately 180 degrees to invert the loaded railcar, causing the load to fall out of the railcar. Simultaneously, the railcar cover is rotated about one longitudinal sill of the railcar away from the opposing railcar sill. The unloaded railcar is then rotated in reverse direction back into an upright position, while the railcar cover is simultaneously rotated from an open position into a closed position atop the railcar, the bracing arms are removed, and the unloaded railcar is rolled out of the dumper. It will be appreciated by those skilled in the art that other variations of the preferred embodiment may also be practiced without departing from the scope of the invention.

1. A method for opening a railcar cover within a rotary dumper, comprising the steps of:
a. moving a railcar having a railcar cover thereon into an unloading position within a rotary dumper; and
b. rotating the railcar approximately 180 degrees in a forward direction while simultaneously rotating the railcar cover about one longitudinal side in a reverse direction into an open position.

2. The method of claim 1, wherein the railcar cover is locked to the railcar, further comprising the intermediate step of unlocking one side of the railcar cover from the corresponding railcar sill.

3. The method of claim 1, wherein the rotary dumper comprises a plurality of lifting components, further comprising the intermediate step of engaging the railcar cover with the plurality of lifting components.

4. A method for unloading a loaded railcar in a rotary dumper, comprising the steps of:
a. moving a railcar having a railcar cover thereon into an unloading position within a rotary dumper and bracing the railcar for inversion;
b. rotating the railcar approximately 180 degrees in a forward direction while simultaneously rotating the railcar cover about one longitudinal side in a reverse direction into an open position;
c. maintaining the railcar in an approximately inverted position until the load has been unloaded;
d. rotating the inverted railcar in a reverse direction back into an upright position, while simultaneously rotating the railcar cover in a forward direction about one longitudinal side into a closed position atop the railcar; and
e. unbracing the railcar and moving it out of the rotary dumper.

5. The method of claim 4, wherein the railcar cover is locked to the railcar, further comprising the additional step after step a) of unlocking one side of the railcar cover from the corresponding railcar sill, and the additional step after step d) of locking the railcar cover to the corresponding railcar sill.

6. The method of claim 4, wherein the rotary dumper comprises a plurality of lifting components, further comprising the additional step after step a) of engaging the railcar cover with the plurality of lifting components, and the additional step after step d) of disengaging the lifting components from the railcar cover.
